(19) United States
(12) Patent Application Publication
(10) Pub. No.: US 2020/0179961 A1
(43) Pub. Date: Jun. 11, 2020

(54) FURTHER IMPROVEMENTS IN OSCILLATING SPRINKLERS AND OTHER SPRINKLER SYSTEMS

(71) Applicant: MELNOR, INC., Winchester, VA (US)

(72) Inventors: Mark Tanner, Winchester, VA (US); Vicky Michael, Winchester, VA (US); John Cataldo, Winchester, VA (US); Thomas Murray, Philadelphia, PA (US); Christopher Murray, Philadelphia, PA (US); Breanna Stachowski, Elma, NY (US); Jason Zerweck, Media, PA (US)

(73) Assignee: MELNOR, INC., Winchester, VA (US)

(21) Appl. No.: 16/703,785

(22) Filed: Dec. 4, 2019

Related U.S. Application Data
(60) Provisional application No. 62/775,313, filed on Dec. 4, 2018.

(51) Int. Cl. B05B 3/18; B05B 3/06; A01G 25/09

(52) U.S. Cl. CPC B05B 3/18; F16H 3/24; A01G 25/097; B05B 3/06

(57) ABSTRACT

An improved traveling sprinkler is provided in which, e.g., a) a water tank is supported on a support surface of a base member at a forward position of a traveling sprinkler system from a water flow path that extends upright through the base member or b) a water tank includes a float valve contained within a removable cap on a top wall of the tank.

The present application claims priority to U.S. Provisional Application No. 62/775,313 filed Dec. 4, 2018, the entire disclosure of which is incorporated herein by reference. The preferred embodiments of the present invention provide improvements in traveling sprinkler systems and methods.

### BACKGROUND

The preferred embodiments of the present invention provide improvements in traveling sprinkler systems and methods. Traveling sprinklers include sprinkler devices that move during operation in order to vary the location of discharge of water from the sprinkler system during usage. In some systems, in order to provide sufficient traction for traveling movement of a traveling sprinkler device, the sprinkler device is weighted. The present invention provides substantial improvements in a traveling sprinkler system in which the traveling sprinkler is weighted by filling of a water reservoir within the traveling sprinkler device.

Among other things, the present invention provides substantial improvements over systems and methods set forth in the following patents and publications, the entire disclosures of which are all incorporated herein by reference.

1. U.S. Pat. No. 3,081,038;

2. U.S. Pat. No. 2,883,116;

3. U.S. Pat. No. 3,526,364;

4. U.S. Pat. No. 7,207,503;

5. U.S. Pat. No. 2,249,211;

6. U.S. Patent Application Publication Number 2007/0290071;

7. U.S. Pat. No. 9,533,322;

8. U.S. Pat. No. 4,883,228;

9. U.S. Pat. No. 105532375 B.

Among other things, the present invention provides substantial benefits and advantages over existing traveling sprinklers, such as, e.g., the water-filled sprinkler described in the above-referenced U.S. Pat. No. 3,081,038. For example, the operation and functionality of the system of U.S. Pat. No. 3,081,038 has substantial limitations that are overcome by embodiments of the present invention.

The present application also improves upon concepts set forth in co-pending application Ser. No. 62/774,108, entitled Improvements in Oscillating Sprinklers and Other Sprinkler Systems, filed on Nov. 30, 2018, the entire disclosure of which is also incorporated herein by reference.

### SUMMARY OF THE PREFERRED EMBODIMENTS

The preferred embodiments overcome the above and/or other problems in the background art.

According to some embodiments, a traveling sprinkler system is provided that includes: a base member supporting each of a gear mechanism, at least one rotating sprinkler arm, a plurality of wheels including at least one wheel driven via said gear mechanism, and a water tank; said water tank being supported upon a support surface of the base member; a water flow path extending upright through said base member from a location proximate a bottom of the base member upward and through a top wall of the base member to at least one laterally extending sprinkler arm, said water flow path including a rotated shaft that is caused to rotate by water flow through said water flow path, and said rotated shaft having a gear mechanism for imparting driving motion for the at least one when driven via said gear mechanism; and said water tank being supported on said support surface of said base member at a forward position of said traveling sprinkler system from said water flow path that extends upright through said base member.

In some examples, said base member is made from a molded plastic material.

In some examples, a bottom of said water tank is lower than a bottom of said rotated shaft.

In some examples, said water tank has a water inlet at a bottom-most point of the water tank.

In some examples, the bottom of said water tank slopes downwardly to said water inlet.

In some examples, a junction between a rear wall of said water tank and a front wall at an upper end of the base member includes a handle portion for manually holding the traveling sprinkler system.

In some examples, said traveling sprinkler system has a handle portion formed at a central top region of the traveling sprinkler.

In some examples, said traveling sprinkler system includes a handle portion formed within a top of the base member and a corresponding recess within the top of the water tank to facilitate grasping of the handle portion.

In some examples, said tank includes a float valve contained within a removable cap on a top wall of said tank.

In some examples, said float valve includes a buoyant member that seals at least one air passage opening within the cap when the water level within the tank reaches the buoyant member, and that unseals the at least one air passage opening within the cap when the water level within the tank lowers below the buoyant member.

In some examples, said buoyant member is a floatable ball shaped member.

In some examples, said buoyant member is a generally T-shaped member having a lower sealing o-ring or other member.

In some examples, the sprinkler system includes two rear wheels that are driven via the gear mechanism and a front wheel that is configured to roll along a hose.

According to some other embodiments, a traveling sprinkler system is provided that includes: a base member supporting each of a gear mechanism, at least one rotating sprinkler arm, a plurality of wheels including at least one wheel driven by said gear mechanism, and a water tank; said water tank being supported upon a support surface of the base member; a water flow path extending upright through said base member from a location proximate a bottom of the base member upward and through a top wall of the base member to at least one laterally extending sprinkler arm, said water flow path including a rotated shaft that is caused to rotate by water flow through said water flow path, and said rotated shaft having a gear mechanism for imparting driving motion for the at least one when driven via said gear mechanism; and wherein said tank includes a float valve contained within a removable cap on a top wall of said tank.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF THE DRAWINGS

The preferred embodiments of the present invention are shown by a way of example, and not limitation, in the accompanying figures, in which:

FIG. 1 is a perspective view of a traveling sprinkler system according to a first embodiment of the invention;

FIG. 2 is a cross-sectional side view of a traveling sprinkler system according to a second embodiment of the invention;

FIG. 3 is a cross-sectional side view of a top section of a tank employed within an alternative embodiment similar to the embodiment shown in FIG. 2, having a modified valve structure;

FIGS. 4-9 show a third embodiment of the invention employing a traveling sprinkler systems that is similar to the embodiment shown in FIG. 2, wherein:

FIG. 4 is a top view of a traveling sprinkler system according to the third embodiment of the invention;

FIG. 5 is a front-right-top perspective view of the traveling sprinkler system shown in FIG.

4;

FIG. 6 is a right side view of the traveling sprinkler system shown in FIG. 4;

FIG. 7 is a front view of the traveling sprinkler system shown in FIG. 4;

FIG. 8 is a bottom view of the traveling sprinkler system shown in FIG. 4;

FIG. 9 is a front-left-top exploded perspective view of the traveling sprinkler system shown in FIG. 4 with the components of the system separated for explanatory purposes;

FIG. 10 is an enlarged view of the cap and float valve portions of FIG. 9 to facilitate reference;

FIG. 11 is an enlarged view of the gear chamber and gear mechanism portions of FIG. 9 to facilitate reference;

FIG. 12 is an enlarged view of the top half of the base shown in FIG. 9 to facilitate reference;

FIG. 13 is an enlarged view of the combined sprinkler arm and rotated shaft assembly shown in FIG. 9 to facilitate reference; and

FIG. 14 is a rear view of the gear mechanism, shown in FIG. 9, according to some illustrative examples of the gear mechanism structure of the third embodiment.

In the accompanying figures, elements having like functionality or purposes are depicted with like reference numbers.

### DETAILED DESCRIPTION OF THE PREFERRED EMBODIMENTS

While the present invention may be embodied in many different forms, the illustrative embodiments are described herein with the understanding that the present disclosure is to be considered as providing examples of the principles of the invention and that such examples are not intended to limit the invention to preferred embodiments described herein and/or illustrated herein.

### Introduction to the Preferred Embodiments

It should be understood that such illustrative embodiments can be modified or adapted by those in the art based on this disclosure and knowledge in the art. For example, the illustrative embodiments shown can be modified to incorporate mechanisms or features of one or more of the patents and applications incorporated herein by reference herein.

In the accompanying figures detailing illustrative embodiments, such embodiments are illustrated, dimensioned and sized in the drawings to scale in some preferred embodiments. In addition, the accompanying figures showing such illustrative embodiments also depict preferred color arrangements in some preferred embodiments. Although scaling, coloring and the like can be varied by those in the art, such attached figures show some preferred embodiments thereof.

In some embodiments, a water filled traveling sprinkler is provided that eliminates or reduces the need for sprinkler repositioning (e.g., by a user or operator having to physically move the sprinkler). In some embodiments, a self-filling and self-emptying water-filled ballast reservoir is employed (e.g., see light blue region over the front wheel in the illustrated example). In some embodiments, the device uses existing rotating spray arms and a ground traction motor mechanism to establish movement. As shown, in some embodiments, the device includes a guide wheel or pair of guide wheels to following along a garden hose or the like during use.

In some embodiments, concepts disclosed herein can be combined with one or more of the concepts disclosed in the above-noted application No. 62/774,108, the entire disclosure of which is incorporated herein by reference.

### Detailed Description of Illustrative Preferred Embodiments

In the following discussion, while a plurality of embodiments are discussed, it should be understood that the operation and functionality and features within each of the discussed embodiments are the same in some implementations of each of the embodiments. Aspects within each of the embodiments, thus, can be applied and should be understood as being applicable to each of the embodiments, unless described as not being applicable.

### First Embodiment

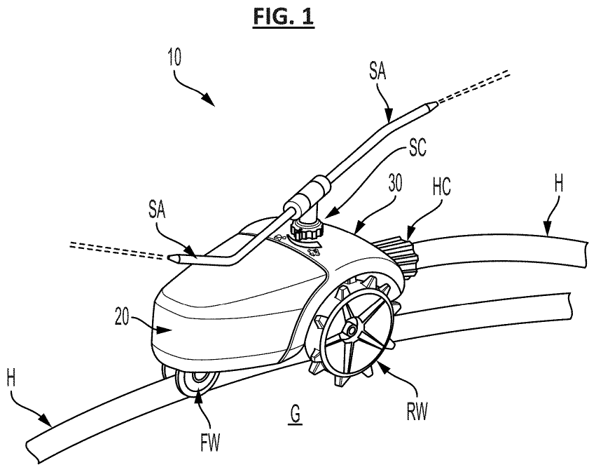

FIG. 1 shows a first illustrative embodiment of the invention. In this illustrated embodiment, a traveling sprinkler 10 is provided that includes a base 30 that supports a water tank 20. As shown, the base 30 also supports two large rear wheels RW that straddle a hose H. In this embodiment, the base 30 also extends beneath the tank 20 and supports a channel-shaped front wheel FW that is configured to roll along the hose H. In the preferred embodiment, the two large rear wheels RW have enlarged ground-engaging spikes to facilitate traction traveling over grass and other ground surfaces G.

As illustrated, the hose H is connected to the traveling sprinkler 10 via a hose connector HC, which includes complementary threads that threadingly engage with corresponding threads on an inlet of the traveling sprinkler 10. For example, the hose connector HC can include common external threads that are threaded into a threaded receiving inlet hole within the traveling sprinkler 10. The interior of the traveling sprinkler includes a gear mechanism for imparting rotation to the rear wheels RW due to incoming water supplied to the traveling sprinkler 10 via the hose H. The incoming water supplied to the traveling sprinkler also causes the sprinkler arms SA to rotate, which, in turn, leads to rotational distribution of water from the traveling sprinkler 10. Due to the rotation of the rear wheels RW, while the front wheel FW straddles over the hose H, the traveling sprinkler is caused to travel along the hose with the hose acting as a guiding track or rail for the traveling sprinkler 10.

In use, a user can simply reposition the hose H over a ground surface as desired in order to adjust the traveling path of the traveling sprinkler 10.

As also shown in FIG. 1, in this first embodiment, the base 30 is also preferably configured to contain a gear mechanism (not shown) for imparting rotation of the rear wheels RW due to rotational motion imparted to the sprinkler arms SA due to the flow of water through the sprinkler system. In addition, the traveling sprinkler 10 also preferably includes a speed control adjuster SC provided on an upper surface of the base 30, such as, e.g., a knob or dial, as shown, in order to adjust the traveling speed of the traveling sprinkler 10 along the hose H. In some embodiments, turning or otherwise moving the knob or dial of the speed control adjuster SC causes engagement/disengagement of different gears so as to impart different rotational speeds to the rear wheels based on the same water flow through the sprinkler arms SA. In some alternative embodiments, turning or otherwise moving the knob or dial of the speed control adjuster SC can cause engagement/disengagement of a braking system that slows the rotational speed of the rear wheels RW by applying a resistive braking pressure at a slower speed.

In some preferred implementations, water is initially directed into the tank 20 upon initially attaching the hose H to the inlet of the traveling sprinkler via the hose connector HC and supplying water through the hose. In this manner, the tank 20 preferably initially fills with water in order to increase the weight of the traveling sprinkler. Then, upon filling of the tank 20, the water is preferably directed through the traveling sprinkler 20 and discharged via the sprinkler arms SA. At this time, the rotation of the sprinkler arms SA is preferably employed to impart rotational movement to the rear wheels RW to effect forward movement of the traveling sprinkler.

In this illustrative first embodiment, the tank 20 is preferably self-filled by directing water into the tank as discussed above until the tank is full. At the time the tank is full, the water is, thus, preferably no longer able to enter the tank 20 and then proceeds through the traveling sprinkler to impart rotation. In some preferred embodiments, the rotational sprinkler arms SA can be configured similar to that of any known rotational sprinkler arms known in the art. Moreover, the gear mechanisms for imparting rotation to the rear wheels RW can also be configured similar to that known in the art.

In the preferred configuration of the first embodiment, the water tank is configured to also be self-emptying upon turning off of the sprinkler system. By way of example, in some illustrative embodiments, upon disconnecting the hose H via the hose connector HC, the tank can simply empty due to opening of an inlet port which enters at a lower end of the tank 20.

In the preferred configuration of the first embodiment, as shown in FIG. 1, the water tank 20 is configured to be located forward of the rear wheels RW. In this manner, a simple, compact and effective traveling sprinkler structure can be achieved. For example, the distribution of the weight of the water in the tank at a toward location from the rear wheels RW helps to achieve substantial ground traction forces through the rear wheels RW, while concurrently enabling internal gearing to be readily located proximate the rear wheels RW, and while facilitating mounting of the rotating sprinkler arms and related mechanisms proximate the rear wheels RW, upon the same base 30 that supports the rear wheels. Moreover, as shown, this structure also enables the sprinkler arms SA to be located substantially above the rear wheels RW in some implementations.

Although FIG. 1 illustrates the tank 20 having a rear end that does not overlap the front-most end of the rear wheels RW at least at a lower end of the tank, in some embodiments, the tank 20 can extend at least partly rearwardly of a front end of the rear wheels RW. However, in some preferred embodiments, the tank 20 is located entirely forward of the rear wheels RW, while in some other embodiments, at least a bottom of the tank 20 is located entirely forward of the rear wheels RW (similar to that shown), while in some other embodiments, the tanks 20 is located entirely forward of at least an axis of a center axle of the rear wheels, while in some other embodiments, at least a bottom of the tank 20 is located entirely forward of an axis of a center axle of the rear wheels RW. In other, less preferred, embodiments, the tank 20 can be located such that a rear end of the tank does not overlap a rearmost end of the rear wheels RW at least at a lower end of the tank. In other, even less preferred embodiments, the tank 20 can extend so as to overlap with the entirety of the rear wheels RW.

### Second Embodiment

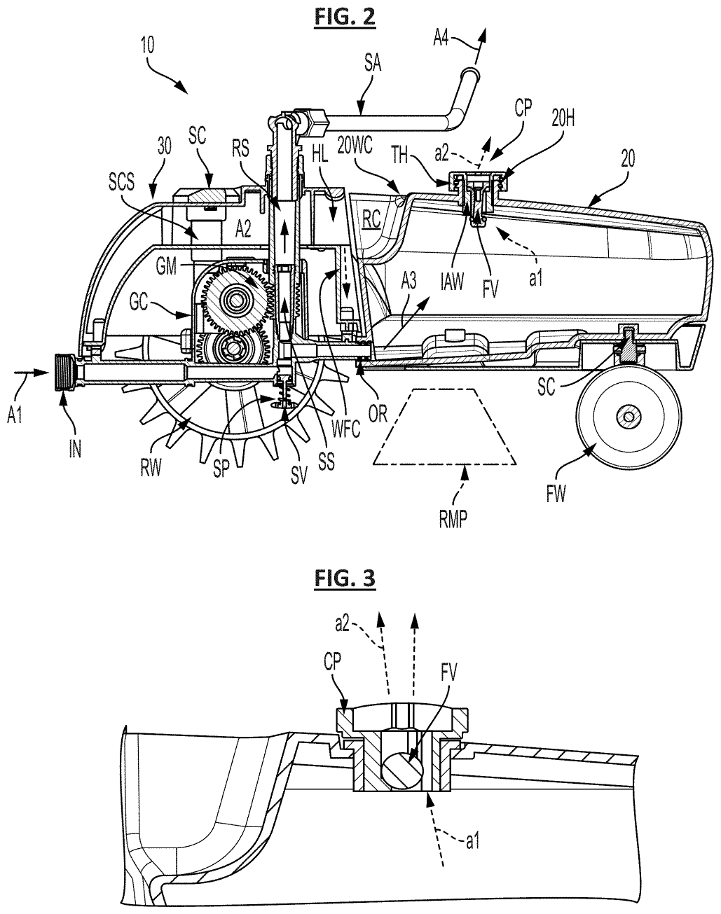

FIG. 2 shows a second illustrative embodiment of the invention, which is similar to the embodiment shown in FIG. 1.

In the embodiment shown in FIG. 2, a similar traveling sprinkler 10 is provided that includes a base 30 that supports a water tank 20. As shown, the base 30 again supports two large rear wheels RW for straddling a hose H (like that shown in FIG. 1). In this second embodiment, the base 30 also extends beneath the tank 20 (as plainly shown in FIG. 2) and supports a channel-shaped front wheel FW that is configured to roll along the hose (like that shown in FIG. 1). In the preferred embodiment, as with the first embodiment, the two large rear wheels RW have enlarged ground-engaging spikes to facilitate traction traveling over grass and other ground surfaces.

In use, a hose is connected to the traveling sprinkler 10 via a hose connector, which includes complementary threads that threadingly engage with corresponding threads on an inlet of the traveling sprinkler 10 such as to direct water into the traveling sprinkler along the path of the arrow A1 shown in FIG. 2. As shown in FIG. 2, the interior of the traveling sprinkler includes a gear mechanism GM for imparting rotation to the rear wheels RW due to incoming water supplied to the traveling sprinkler 10 via the hose.

In operation, water initially enters the inlet along the flow path A1 and enters the tank 20 through the rearside bottom inlet such as to enter the tank 20 along the path of the arrow A3. As water enters the tank 20, the water level will rise within the tank until the water level reaches the float valve FV that is located within the removable cap CP at the top end of the tank 20. Prior to the water level reaching the float valve, the float valve FV preferably allows air to flow there-through, whereby water can readily enter the tank without resistance due to internal air pressure. However, upon the water level contacting the float valve FV, the float valve is preferably raised such that the valve is closed when the water level within the tank 20 is full. At that point, the water will no longer diverted into the tank 20, but will substantially follow the flow path A2 shown in FIG. 2 in which the water travels upwardly within the rotatable shaft RS that is connected to the sprinkler arms SA. In operation, as the water is then discharged from the sprinkler arms SA via the flow path A4 shown in FIG. 2, the force of the water via the sprinkler arms will cause a rotational turbine effect causing the sprinkler arms to rotate around an axis of the rotational shaft RS, with the rotated shaft RS rotating with the sprinkler arms SA. In the preferred configuration, the sprinkler arms SA are fixedly connected to the rotated shaft RS that extends vertically through the base 30 of the traveling sprinkler. As the rotated shaft RS rotates, an external thread around the rotated shaft is caused to rotate that in turn imparts a rotational motion to mating teeth of a gear of the gear mechanism GM as shown in FIG. 2, such as to impart rotational motion that is directed to an axle of one or both of the rear wheels RW (such as, e.g., via a gear chain of two or more connected gears).

As also shown in FIG. 2, in the preferred embodiments, the rotated shaft RS is mounted so as to rotate around a co-axial stationary shaft SS that is fixedly mounted to create a flow path A2 leading upwardly from the water-flow tubing extending from the inlet via the flow path A1. In some embodiments, one or more o-ring can be located between a perimeter of the stationary shaft SS and the interior of the rotated shaft RS so as to help to avoid leakage of water flowing along the flow path A2.

As with the first embodiment, in operation, the incoming water supplied to the traveling sprinkler causes the sprinkler arms SA to rotate, which, in turn, leads to rotational distribution of water from the traveling sprinkler 10. Due to the rotation of the rear wheels RW, while the front wheel FW straddles over a hose, the traveling sprinkler is caused to travel along the hose with the hose acting as a guiding track or rail for the traveling sprinkler.

In this manner, the sprinkler arms SA act as a turbine and the rotated shaft RS having the exterior screw threads operates as a worm gear that drives the entire gearing system of the gear mechanism GM that is located within the gear case GC. The two long sprinkler arms SA of the sprinkler are configured such that the water pressure received via a supply hose causes the sprinkler arms SA to rotate clockwise. This rotation drives the worm gear of the rotated shaft RS. Although two sprinkler arms are shown in the illustrated most preferred embodiment, it should be appreciated that in other embodiments any number of sprinkler arms can be selected as desired.

As with the first embodiment, in use, a user can simply reposition a hose over a ground surface as desired in order to adjust the traveling path of the traveling sprinkler 10.

As with the embodiment shown in FIG. 1, in the preferred embodiments, the traveling sprinkler 10 shown in FIG. 2 also preferably includes a speed control adjuster SC provided on an upper surface of the base 30, such as, e.g., a knob or dial, as shown, in order to adjust the traveling speed of the traveling sprinkler 10 along the hose. In some embodiments, turning or otherwise moving the knob or dial of the speed control adjuster SC causes engagement/disengagement of different gears so as to impart different rotational speeds to the rear wheels based on the same water flow through the sprinkler arms SA. In some preferred embodiments, the speed control adjuster SC operates as a switch that changes the speed of the traveling sprinkler 10 between a faster speed (Hi), a slower speed (slow), and a neutral position (i.e., no movement), which is achieved by moving one gear within the gear mechanism such as to change the gear ratios. While in some other embodiments, additional speed variations could be imparted, in the preferred embodiments, at least two different speed settings along with a neutral (non-moving) speed setting is selectable with the speed control adjuster SC.

As with the first embodiment, in some alternative embodiments, turning or otherwise moving the knob or dial of the speed control adjuster SC can cause engagement/disengagement of a braking system that slows the rotational speed of the rear wheels RW by applying a resistive braking pressure at a slower speed.

In the preferred embodiments, the tank 20 includes a flow control valve FC that is mounted within a removable cap CP. In the preferred embodiment shown in FIG. 2, the cap CP includes internal threads TH on an interior of an outermost annular wall that threadingly engage with external threads around an upwardly extending cylindrical-opening member 20H extending from the top of the tank 20 having a central opening that receives a depending interior annular wall IAW of the cap CP. As shown in FIG. 2, the interior annular wall IAW provides a central passageway that receives a float valve FV. As also shown in FIG. 2, in the preferred embodiment, the interior annular wall IAW includes a lower region with a narrower tubular width, and an upper region with a wider tubular width, and the float valve has a substantially T-shaped cross-sectional shape (as shown) with a wider head of the T-shaped float valve spanning the wider upper region and a narrower base of the T-shaped float valve spanning the narrower lower region. Moreover, the T-shaped float valve FV also includes at least one air channel enabling air to flow between the periphery of the T-shaped float valve FV and the interior annular wall IAW of the cap CP, when the T-shaped float valve is in a low position within the cap CP (as shown in FIG. 2).

During operation, when water is introduced into the tank 20, the water level will rise in the tank with the float valve FV in a lower position (e.g., due to the weight of the float valve), such that air can concurrently escape the tank 20 as water enters the tank 20. Then, when the water in the tank reaches the float valve FV, the float valve FV will rise along with the water level (e.g., due to buoyancy of the float valve), such that the float valve eventually raises to a position in which the at least one air channel is occluded by the float valve, and, thus, such that air no longer escapes the float valve and the tank is in a sealed condition. As shown in FIG. 2, in some embodiments a lower distal end of the float valve FV can include, e.g., an external o-ring that creates a seal with the lower interior of the interior annular wall IAW when the float valve is raised due to buoyancy forces from the water.

In the preferred embodiments, this float valve at the top of the tank, thus, remains open to allow air to leak out until the water reaches the top, at which point the water forces the valve shut and seals the tank. When the sprinkler is turned off (e.g., when the hose is removed), in the preferred embodiments, the valve will open again as the stored water is released from the tank. In addition, in the preferred embodiments, the entire valve assembly of the float valve is located within the cap CP, whereby the entire valve assembly can be screwed off like a cap. Among other things, this configuration enables a user to simply remove the cap CP and tip the device to allow for fast draining of the tank. Additionally, this configuration also enables quick and easy replacement and/or servicing of such a float valve.

Accordingly, the float valve is preferably configured to allow air to freely flow through the tank during filling. Additionally, the airflow is preferably sealed by the valve once the tank is filled. Among other things, this valve structure helps to help avoid spilling or the like during use. In addition, the cap enables the tank to be readily opened.

In the preferred embodiments, as shown in FIG. 2, the traveling sprinkler 10 includes a shut-off valve SV extending downwardly from the bottom of the water tubing that leads from the inlet IN. In the preferred embodiment, the shut-off valve SV is spring biased downwardly via a coil spring SP to an open position. Accordingly, during normal use operation of the traveling sprinkler 10, the valve SV freely allows water to flow there-through. In the preferred embodiments, the shut-off valve SV comes with a ramp member RMP (see schematically illustrated ramp member RMP shown in dashed lines in FIG. 2) that is placed along the user's hose at a location at which the traveling sprinkler 10 is desired to stop to the end the watering cycle. When the traveling sprinkler reaches the location of the ramp, the traveling sprinkler will travel over the ramp, whereby the ramp will act as a cam and push the valve SV upward, such that the ramp pushes the valve upward to a closed position. At that time, the water will, thus, cease to flow through the traveling sprinkler, and the sprinkler movement and operation will stop at the location of the ramp.

In the preferred embodiments, the tank 20 and base member 30 are formed from molded plastic material, with the base member preferably being a more rigid material to maintain the structural rigidity of the components supported on the base, and with tank preferably being made with a clear or semi-clear material such that the water within the tank can be observed through the tank wall. For example, the tank 20 can be made with a white plastic having sufficient translucence to visually view through the tank wall. In some examples, the base 30 can be made with a more rigid plastic having, e.g., a dark green or other opaque color.

In the preferred embodiments, as shown in FIG. 2, the base member 30 is also configured to have a top handle portion HL via which a user can readily grasp and lift the traveling sprinkler 20. In the preferred embodiment, the handle portion HL is substantially centrally located between the front-most and rear-most ends of the traveling sprinkler 10. In this manner, the handle portion HL can be readily used to lift the traveling sprinkler 10 with one hand with a user's fingers extending underneath a top wall of the base 30. As shown in the cross-sectional view in FIG. 2, the top wall of the base 30 at the handle portion HL preferably includes a transversely extending rib having a curved cross-section to facilitate gripping by a user's fingers. In the preferred embodiment, the handle portion HL is formed at a junction between the tank 20 and the base 30, as shown. Moreover, in the preferred embodiment, the handle portion includes a recess RC formed within the tank 20 for receiving a user's hand/fingers. Preferably, a center of the traveling sprinkler 10 in the lengthwise direction (between rear-most and front-most ends of the sprinkler) is located within the region of the handle portion HL or recess RC.

In the preferred embodiments, the top wall of the tank 20 extends downwardly at a pitch angle from the location of the cap CP to the front-most end of the traveling sprinkler 10. In this manner, in the event that any water is emitted from the cap CP, the water will drain downwards towards the front of the sprinkler and away from the gear mechanism GM and other components. In the preferred embodiments, the top wall of the tank 20 extends downwardly at a pitch angle from the recess to the front-most end of the traveling sprinkler 10. In some preferred embodiments, the top wall of the tank includes one or more water channels 20WC (partly shown in FIG. 2) which extend(s) along the length of the top of the tank 20 such as to help direct water along the top of the tank to the front-most end of the traveling sprinkler.

In some preferred embodiments, the junction area between the base 30 and the tank 20 proximate (e.g., beneath) the handle portion HL includes a water flow channel in the form of a recess or conduit that facilitates downward flow of water between the base 30 and the tank 20 to an opening at the bottom end of the traveling sprinkler 10, such that water does not fill within the recess RC, the handle portion HL and/or become undesirably directed to the gear mechanism GM or interior of the base 30.

In the preferred embodiment, as shown in FIG. 2, the water inlet IN an tubing leading to the tank prior to the shut-off valve SV is extends below a lower-most end of the tank 20. In that manner, upon opening of the shut-off valve SV, the water within the tank will all freely flow out of the traveling sprinkler, without significant water remaining within the traveling sprinkler 10. Along the same lines, the bottom wall of the tank 20 is preferably configured to have an inclination that is consistently downward towards the rear most end of the tank 20 as shown in FIG. 2. Moreover, as also illustrated in FIG. 20, the tank 20 is also preferably constructed such that a center of the tank in the widthwise direction is also at a lowest point within the tank. In this manner, all of the water within the tank will preferably freely flow both to the longitudinal center of the tank 20 and also rearwardly such as to exit via the inlet port leading into the bottom of the tank 20 at a bottom-most point of the tank 20.

In the preferred embodiment, the tank 20 can be readily mounted upon the base 30 by initially lowering a rear end of the tank onto the base 30 and sliding the projecting inlet coupling tube element at the bottom-most point at the rear of the tank 20 (see FIG. 2) over the water inlet tubing (as shown). When installed (as shown), at least one o-ring OR is preferably employed to provide a water-tight seal there-between. After the tank 20 is located upon the base 30 as discussed above, the tank 20 is preferably secured to the base via one or more fixing members, such as, e.g., a bolt or screw SC. In the illustrated embodiment, the same bolt or screw SC that is used to support a bracket for the front wheel is also employed to help fix a front end of the tank 20 to the base 30. In some preferred embodiments, three such bolts or screws SC are employed. It should also be appreciated that the bolts or screws SC preferably do not penetrate through a wall of the tank but are received within threaded portions within a wall of the tank such as to help ensure sealing of water within the tank.

FIG. 3 shows an alternative construction of the cap CP and float valve FV of the second illustrative embodiment described above. In this alternative construction, the float valve is configured as a floatation ball that rises within a central conduit of the cap CP along with rising water level within the tank. As shown in FIG. 3, when the water level in the tank is below the bottom of the cap CP, the floatation ball float valve FV will rest upon an inwardly projecting edge at a lower end of the interior wall of the central conduit, while air can freely flow along a path a1 shown in FIG. 3 around the floatation ball float valve FV view one or more grooves within the wall of the central conduit extending around the float valve. After the air travels around the float valve FV which is in this lower position, the air can pass through one or more hole(s) formed in the top of the cap CP (two holes shown in the illustrative example of FIG. 3) such that air exits the tank via the flow path a2 as shown in FIG. 3.

During use, as the water enters the tank and rises within the tank, upon contacting the floatation ball float valve FV, the floatation ball will float on top of the water and rise within the central conduit of the cap CP until it reaches a curved top wall of the cap. In this example, when the floatation ball reaches this top wall, it will seal the holes in the cap, whereby air will no longer be discharged from the tank and water will no longer enter the tank. As with the float valve FV described above in the example shown in FIG. 2, upon lowering of the water within the tank, the float valve FV will be lowered from its sealing position, whereby air can freely enter the tank 20 and water can freely exit the tank 20 as discussed above.

FIG. 3 also illustrates a slightly modified tank 20 top wall structure with a) water channels 20WC omitted and b) without upwardly extending cylindrical-opening member 20H that extends upward from the top of the tank 20 and related structure. In this illustrative embodiment, the cap CP preferably includes threads around a periphery of the cap that are threadingly engaged with internal threads within the hole shown at the top of the tank 20.

Additionally, as with the example shown in FIG. 2, in the embodiment of FIG. 3, the entire cap CP with float valve FV combined structure can be readily removed for easy emptying of the tank 20, cleaning of the tank 20, repair or replacement, or other purposes.

### Third Embodiment

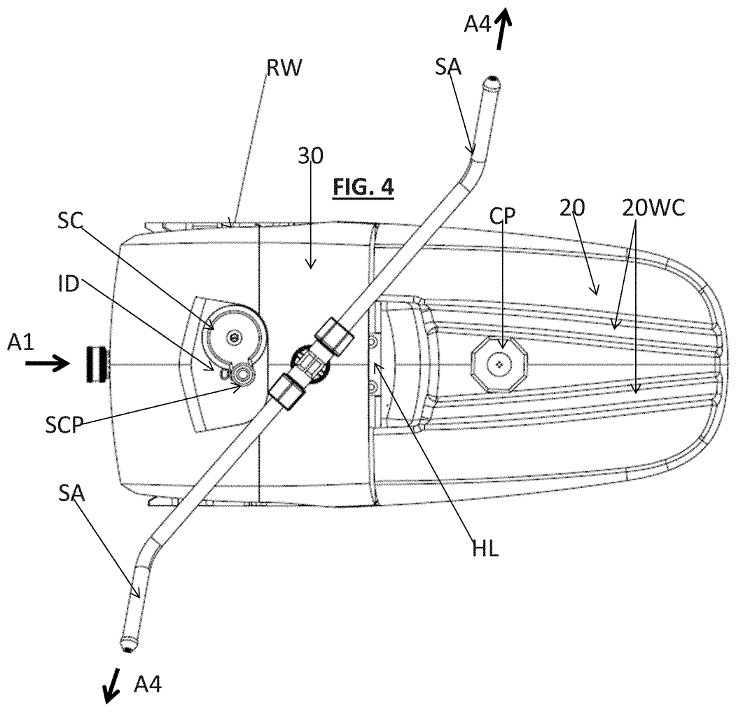

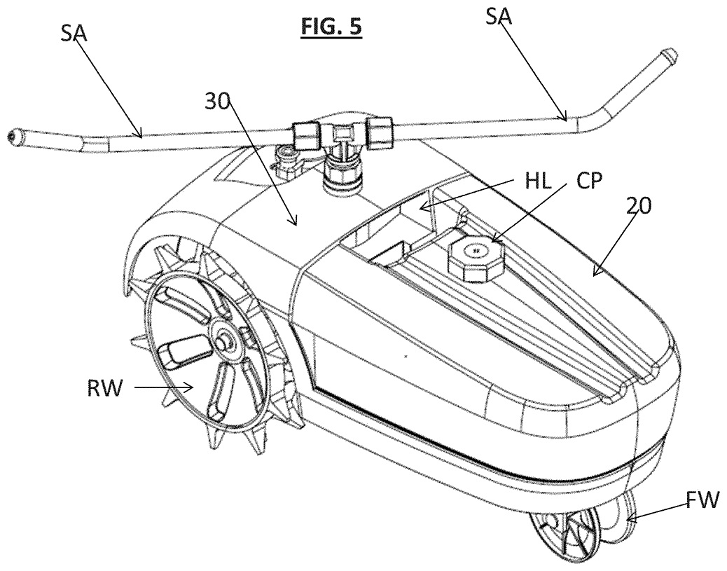

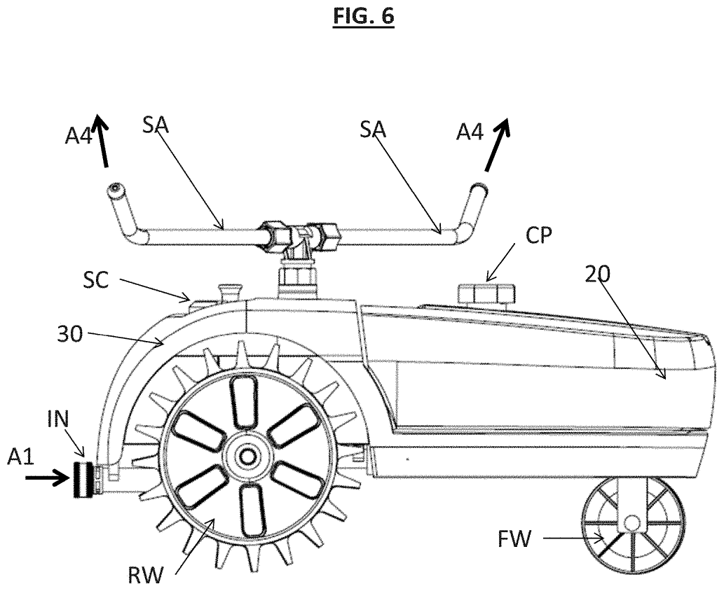

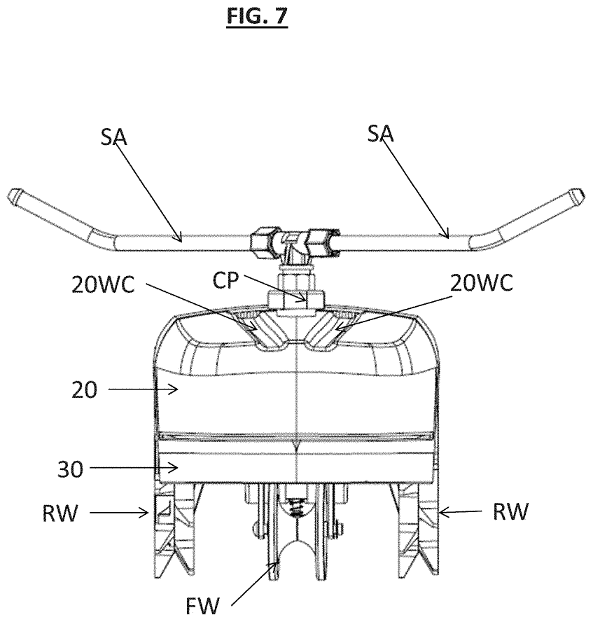

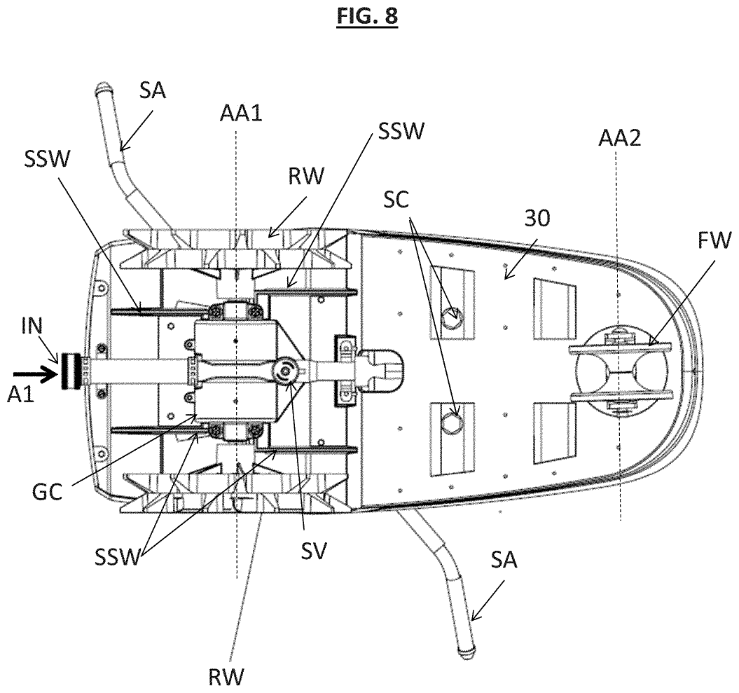

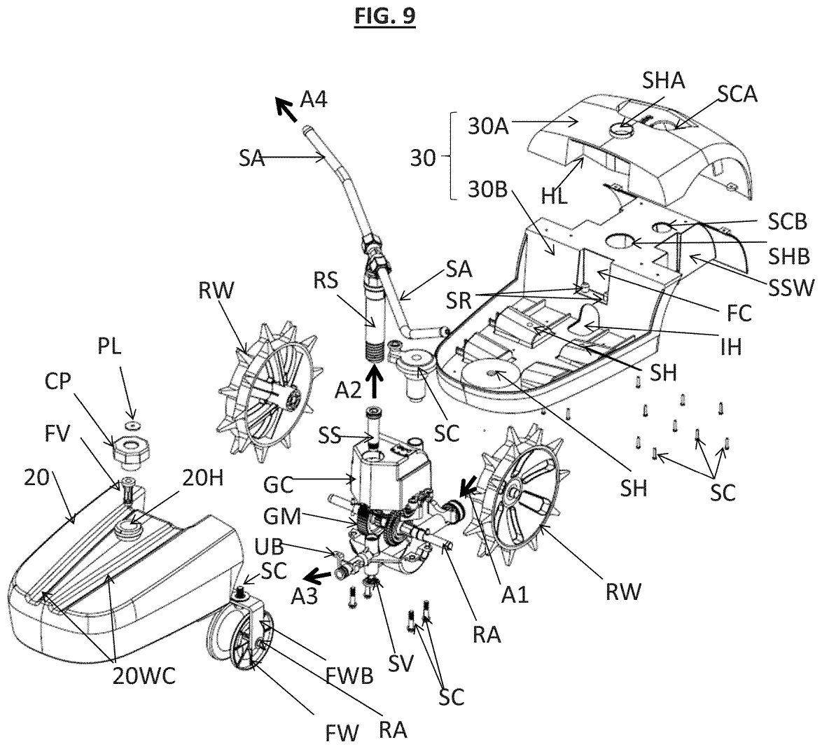

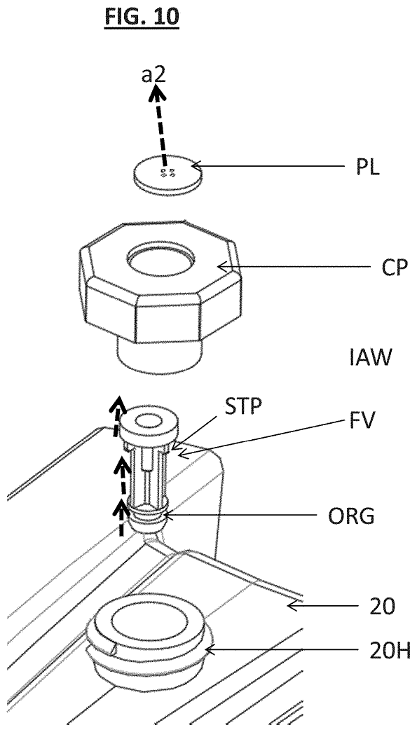

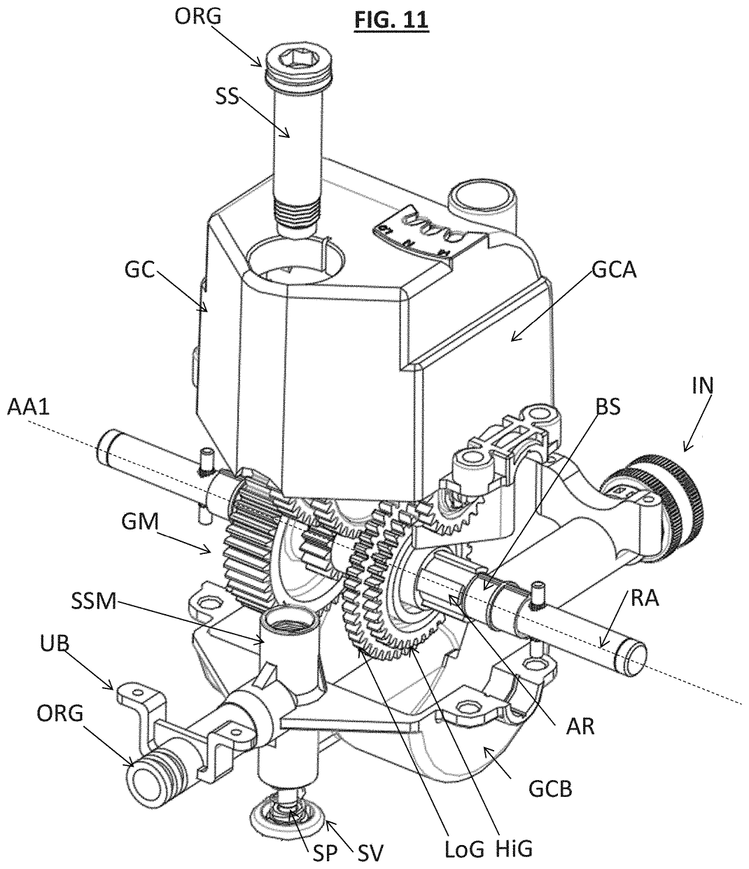

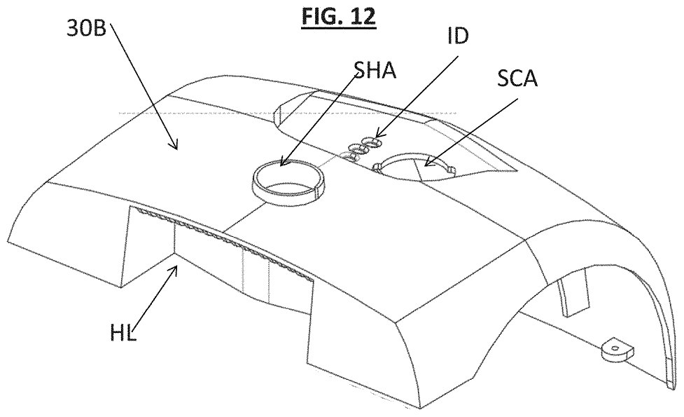

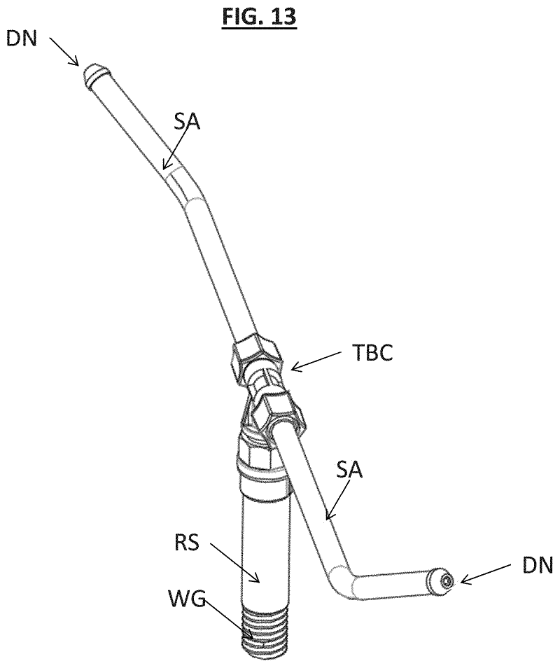

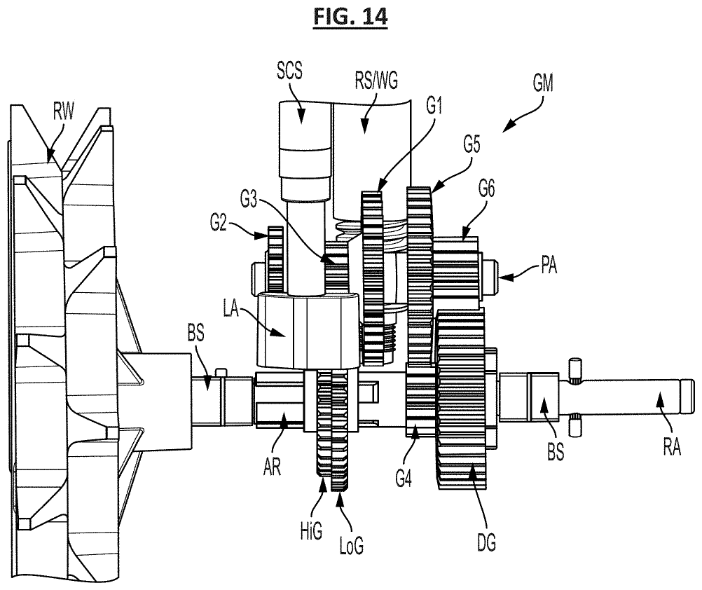

FIGS. 4-9 show a third embodiment of the invention employing a traveling sprinkler 10 that is similar to the embodiment shown in FIG. 2. Towards that end, FIG. 4 is a top view of a traveling sprinkler system according to the third embodiment of the invention, FIG. 5 is a front-right-top perspective view of the traveling sprinkler system shown in FIG. 4, FIG. 6 is a right side view of the traveling sprinkler system shown in FIG. 4, FIG. 7 is a front view of the traveling sprinkler system shown in FIG. 4, FIG. 8 is a bottom view of the traveling sprinkler system shown in FIG. 4, FIG. 9 is a front-left-top exploded perspective view of the traveling sprinkler system shown in FIG. 4 with the components of the system separated for explanatory purposes, FIG. 10 is an enlarged view of the cap and float valve portions of FIG. 9 to facilitate reference, FIG. 11 is an enlarged view of the gear chamber and gear mechanism portions of FIG. 9 to facilitate reference, FIG. 12 is an enlarged view of the top half of the base shown in FIG. 9 to facilitate reference, FIG. 13 is an enlarged view of the combined sprinkler arm and rotated shaft assembly shown in FIG. 9 to facilitate reference, and FIG. 14 is a rear view of the gear mechanism (shown in FIG. 9) according to some illustrative examples of the gear mechanism structure of the third embodiment.

As indicated above, elements having like functionality or purposes are depicted with like reference numbers to that discussed above with reference to the above embodiments. Various elements shown in the third embodiment are similar to that discussed above with respect to the second embodiment. Accordingly, reference is made to the foregoing description for a discussion of such components. It should also be appreciated that aspects of various embodiments can be combined as would be readily apparent based on this disclosure. Thus, any omission of discussion of a particular element or component in relation to one embodiment should not be improperly interpreted that such component or element cannot be applied in other embodiments described herein. On the contrary, aspects of any embodiment can be applied within other embodiments described herein.

Among other things, FIG. 4 shows an illustrative example of the construction of the flow channels 20WC formed in the top surface of the tank 20 according to some illustrative embodiments.

In addition, FIG. 4 also shows an illustrative example of the construction of the speed control mechanism SC according to some illustrative embodiments. In this illustrative third embodiment, the speed control mechanism preferably includes a rotated knob having a projection SCP that is rotatably positioned by rotation of the knob. As discussed below, rotation of this knob leads to axial movement of a gear mechanism in order to adjust gearing of the gear mechanism GM such as to vary the speed of movement of the traveling sprinkler 10 in response to water flow there-through. In the preferred embodiments, the upper surface of the base 30 includes indicia ID adjacent the projection SCP for identification of the particular setting of the speed based on the position of the projection.

In addition, FIG. 4 also shows an illustrative example of the construction of the cap CP and float valve FV structure, in which the cap includes an octagonal outer periphery and four central air flow holes.

As indicated above, the other elements shown in the third embodiment are similar to that discussed above with respect to the second embodiment. Accordingly, reference is also made to the foregoing description for a discussion of such components.

With reference to FIG. 5, the figure illustrates, among other things, an illustrative construction of the rear wheels RW, which can, in some embodiments, be formed of molded plastic material, including weight-reducing through-holes and dual rows of ground-engaging spikes. In addition, FIG. 5 also illustrates a perspective view into the handle portion HL according to some illustrative embodiments. Moreover, FIG. 5 also illustrates the manner in which the base 30 also operates as a fender portion that extends over the rear wheels RW. Towards that end, in the preferred embodiments, the traveling sprinkler is configured with tapered configuration along its entire length, or, in some embodiments, substantially along its entire length, or, in some embodiments, along the length from the front of the tank to a rear of the tank, or, in some embodiments, along at least the front ¼, ⅓, or ½ of the length of the traveling sprinkler. Additionally, the base 30 preferably not only covers an upper side of the rear wheels RW, but preferably extends in front of the rear wheels RW, such as to help direct grass, weeds, sticks or other debris away from the rear wheels RW during operation. Although the base 30 will cover all of the top side and front side of the rear wheels, in some preferred embodiments, the base will cover at least a portion of the rear wheels as viewed from above and at least a portion of the rear wheels as viewed from the front, and preferably more than 50% of the rear wheels as viewed from above and also more than 50% of the rear wheels as viewed from the front, and even more preferably more than rear wheels as viewed from above and at least a portion of the rear wheels as viewed from the front, and preferably more than 75% of the rear wheels as viewed from above and also more than 75% of the rear wheels as viewed from the front. With respect to the covering of the view of the rear wheels as viewed from the front, as there is some required ground clearance, as shown in, e.g., FIG. 6, in some embodiments, the portions of the rear wheels RW covered from a front view are at least a top half of the wheels; moreover, the above noted amounts and percentages only apply to the covered portions within the at least the top half of the wheels and do not include the exposed lower portions. Thus, for example, in some embodiments, the entire top half of the wheels are obstructed from view from a front side of the traveling sprinkler, while in other embodiments, more than 50% of the top half of the rear wheels are obstructed from view from the front side, while in other embodiments, more than 75% of the top half of the rear wheels are obstructed from view from a front side of the traveling sprinkler, etc.

Among other things, FIG. 7 illustrates some further illustrative details according to some implementations of the third embodiment, including the preferred structure of the rear wheels RW according to some illustrative embodiments, as well as the preferred structure of the front wheels according to some illustrative embodiments. As illustrated, the front wheels are preferably sized to accommodate a range of substantially cylindrically-shaped elongated hoses as described above.

As indicated above, FIG. 8 is a bottom view of the traveling sprinkler system shown in FIG. 4.

Among other things, FIG. 8 illustrates illustrative locations for fixing bolts or screws SC that are tightened to fix the tank 20 to the base. Although not seen in FIG. 8, as described above with respect to the second embodiment, the front wheel FW can be mounted via a third fixing bolt or screw SC that is also attached to the tank 20 such as to provide three points of attachment in the illustrated embodiment.

As also shown in FIG. 8, in this illustrative embodiment, the front wheel is mounted to the base 30 via a substantially U-shaped front wheel bracket FWB (see also FIG. 9), employing a bolt or the like as an axle extending along the axis AA2.

As also shown in FIG. 8, in this embodiment, the gear mechanism GM is preferably contained within the gear casing GC in order to protect the mechanism as well as to prevent grass, sticks or debris from interfering with the operation of the gear mechanism GM. As shown, the rear wheels RW include a rear axle RA (see also FIG. 9) that extends through the gear casing GC.

As also shown in FIG. 8, in this embodiment, the base 30 is preferably formed with side support walls SSW (see also FIG. 9) on left and right sides of the base 30 which extend alongside and support the gear casing GC. Towards that end, the gear casing can be fixed to the side support walls and/or to the base 30 proximate the side support walls employing any approximate connections, including for example, screws or bolts and/or other connection mechanisms.

As indicated above, FIG. 9 is a front-left-top exploded perspective view of the traveling sprinkler system shown in FIG. 4 with the components of the system separated for explanatory purposes. In addition, FIG. 10 is an enlarged view of the cap and float valve portions of FIG. 9 to facilitate reference. Furthermore, FIG. 11 is an enlarged view of the gear chamber and gear mechanism portions of FIG. 9 to facilitate reference. Furthermore, FIG. 12 is an enlarged view of the top half of the base shown in FIG. 9 to facilitate reference. And further, FIG. 13 is an enlarged view of the combined sprinkler arm and rotated shaft assembly shown in FIG. 9 to facilitate reference.

As shown in FIG. 9, the left side of the figure shows the tank 20, along with illustrative cap CP and integrated float valve FV structure according to some embodiments. With reference to FIG. 10, the cap CP and float valve FV structure shown in FIG. 9 is enlarged to facilitate reference and viewing of component parts. In the illustrated embodiment, the cap CP includes a central opening at a top thereof, and a plug PL is fixedly attached within the central opening of the cap CP. The plug PL includes a plurality of air holes that allow air to escape from the cap along air path a2 shown with dashed arrows in FIG. 10. As best seen in FIG. 2 in relation to the second embodiment, the interior of the cap CP preferably includes an indented lower step portion that contacts the corner step portions beneath the circular head portion CH, such that the float valve FV is retained within the cap CP as an integrated unit. In some embodiments, the integrated unit can be formed by inserting the valve FC into the central opening of the cap CP and then sealing the center opening with the plug PL so as to retain the float valve FV therein.

As shown in FIG. 10, the bottom of the float valve FV preferably includes an o-ring groove for fitting and retaining an o-ring. In this embodiment, the operation and functionality of the float valve FV is the same as that of the second embodiment shown in FIG. 2 and as discussed above. As illustrated by the dashed arrows in FIG. 10, when the float valve is positioned with the o-ring in a lowered open (non-sealed) position, air preferably flows around the periphery of the float valve and up through the openings in the plug PL to follow the air path a2. As the step portions STP contact the interior of the cap at four spaced apart locations, this structure can readily maintain an air path between the cap and the float valve. As should also be appreciated, the float valve FV is preferably made of a light and buoyant material that will readily float on water so as to be lifted to a sealing position as discussed above, while readily falling to an open position as also discussed above.

As further shown in FIG. 9, the middle of the figure shows the gear case GC and associated gear mechanism GM for mechanical operation of the traveling sprinkler according to some illustrative embodiments. Moreover, as also indicated above, FIG. 11 is an enlarged view of the gear chamber and gear mechanism portions of FIG. 9 to facilitate reference and viewing of component parts.

With reference to FIG. 9, the gear casing GC is mounted (as discussed above) between the side support walls SSW of the base 30 (i.e., on the lower portion 30B of the base 30). As also illustrated in FIG. 9, the water flow tubing proximate the inlet IN is preferably further supported by the base via a U-shaped bracket UB that can be bolted or screwed to screw or bolt receiving holes SR for within the base 30 (see elements SR formed at lower end of flow channel FC {which flow channel FC is discussed further below}).

As shown in FIG. 11, the outlet of the water tube that leads to the interior of the tank 20 includes a plurality of annular grooves ORG for receiving o-rings to sealing engage with the entrance to the tank 20 (as discussed above). Similarly, a top of the stationary shaft SS, which shaft SS is fixedly engaged with the stationary support member SSM via external threads of the stationary shaft SS and interior threads of the stationary support member (as shown in FIG. 11), also includes at least one similar annular groove ORG for receiving an o-ring. As discussed above, this o-ring around the stationary shaft provides a sealing engagement between the periphery of the stationary shaft SS and the interior of the rotating shaft RS that rotates around the stationary shaft as discussed above.

As also shown in FIG. 11, the gear casing GC preferably includes an upper cover portion GCA and a lower bottom portion GCB that are connected together in a manner to be brought together vertically from the positions shown in FIG. 11, such as to have the ends of the axle RA extending through the respective through-holes formed by the members GCA and GCB at left and right sides of the gear casing GC.

In operation, rotation is imparted to the rear wheels RW due to water flowing through the sprinkler system along a flow path A2 (see discussion above with respect to the second embodiment, which is, as indicated above, applicable in this embodiment as well), which causes the sprinkler arms SA to rotate and, hence, causes the rotational shaft RS to rotate along with the sprinkler arms due to being fixedly assembled thereto, and, hence, causes the corresponding gears within the gear mechanism GM to rotate and ultimately cause the axle RA to rotate to, thus, power the rear wheels RW. Although an illustrative embodiment of the gear mechanism is shown and described herein, it should be appreciated that this is merely one illustrative example, and that in other embodiments, any desired manner of imparting rotational motion to the wheels based on the rotation of the rotatable shaft RS can be employed and many different gear trains and gear configurations or other mechanisms, such as, e.g., drive belts and the like, can be employed in other embodiments.

As discussed above, in some preferred embodiments, a speed control mechanism SC is provided which allows for controlling the speed of the traveling sprinkler. Towards that end, in some preferred embodiments, the speed control mechanism SC preferably operates so as to move different sized gears into and out of engagement within the gear mechanism in order to vary the speed setting of the gear mechanism. For example, as shown in FIG. 11, in some embodiments, the speed control mechanism SC can be made to laterally slide gears LoG and HiG along the axial guide rail AR such as to bring either the LoG gear or the HiG gear into engagement within the gear mechanism, whereby varying the speed of the rotary sprinkler 10. In the illustrated embodiment, the gear LoG represents a slower speed (i.e., due to the larger diameter of the gear imparting a slower rotation rate) and the gear HiG represents a higher speed (i.e., due to the smaller diameter of the gear imparting a higher rotation rate). Thus, by laterally moving the position of the gears, a user can select which gearing to apply and, hence, whether to proceed with a faster or slower speed. Additionally, in the preferred embodiments, the user can also manually move the gears LoG and HiG to a neutral position in which neither of the gears engages within the gear mechanism, whereby no movement would be applied and the sprinkler remains in a stationary location.

For further reference, FIG. 14 is a rear view of the gear mechanism shown in FIGS. 9 and 11 according to some illustrative examples of the gear mechanism structure of the third embodiment, which helps to illustrate how multiple speeds and neutral positions can be achieved in some illustrative examples. It is emphasized, however, that in various embodiments, other gear mechanisms and/or motion transmission structures can be used and that this is merely one illustrative example. Towards that end, in the illustrative example shown in FIG. 14, the gear mechanism GM according to this illustrative example, initiates rotation by imparting rotation to the rotated shaft RS having the worm gear WG around the periphery thereof as shown in the back of FIG. 14. This rotation is caused via water flow via the flow path A2 as discussed above. The rotation of the worm then leads to rotation of a first gear G1 which is rotationally supported within the gear casing GC on an axel PA that is supported parallel to the axle RA of the rear wheels. The rotation of this first gear G1, thus, leads to concurrent rotation of the second gear G2 and the third gear G3 which are fixed with the first gear G1. Notably, these gears G1, G2, and G3 also rotate freely around the axle PA.

In order to select a desired speed of the traveling sprinkler 10, a user rotationally adjusts the speed control shaft SCS by manually rotating the speed control SC knob shown in, e.g., FIG. 4 to achieve a desired rotational position of the projection SCP. As illustrated in FIG. 14, the bottom of the speed control shaft SCS includes a lever arm LA that is arranged to laterally move the two joined gears HiG and LoG along the axial guide rail AR so as to adjust the axial position of the two joined gears HiG and LoG. Towards that end, when the knob of the speed controller SC is in a Hi position (for higher speed), the lever arm LA causes the gear HiG to align with the gear G2 such as to impart a higher speed of rotation. However, when the knob of the speed controller SC is in a Lo position (for lower speed), the lever arm LA causes the gear LoG to align with the gear G3 such as to impart a lower speed of rotation. Moreover, when the knob of the speed controller SC is in a Neutral position (for non-movement), the lever arm LA causes both of the gears HiG and LoG to be disengaged (e.g., situated in between the rotating gears G2 and G3) such that the traveling sprinkler does not move.

Although the gearing and motion transfer can be effected in a variety of ways (as discussed above), for illustrative purposes, in this example, once the connected gears HiG and LoG are rotated via either of the gears G2 or G3, the rotation of these gears causes the fourth gear G4 to rotate along therewith. In this regard, the gears HiG, LoG and G4 rotate around the axle RA supported on a cylindrical member that rotates around the axle RA without causing rotation of the axle RA. The rotation of the gear G4, in turn, causes rotation of the gear G5, which is also mounted for rotation around the parallel axle PA, but independently from the gears G1, G2 and G3. The rotation of the gear G5, in turn, causes rotation of the gear G6, which is mounted to rotate with the gear G5 around the parallel axle PA. Then, the gear G6 causes the driving gear DG to rotate. Here, the driving gear is connected to the axle RA, such that rotation of the driving gear DG causes the axle RA to rotate and, hence, to drive the rear wheels RW (i.e., it should be appreciated that the rear wheels are fixed in relation to the axle RA so as to rotate with the axle RA).

Once again, it should be understood that this is merely just one illustrative gear mechanism that can be employed in some illustrative embodiments. FIG. 14 also shows illustrative bushing members BS that are preferably located around the axle RA and that help to align the axle RA with the gear mechanism GM. As best shown in FIG. 11, in the preferred embodiments, the bushing members BS include rib members that are fitted within respective receiving grooves within the gear case cover GCA and the lower gear case bottom GCB so that the bushing members are non-rotationally retained with respect to the gear casing GC.

As also shown in FIG. 9, in the preferred embodiments, although the base member 30 can be formed as a single member, in the illustrated preferred embodiment, the base member 30 preferably includes a supporting bottom member 30B and an aesthetic cover member 30A. In the preferred embodiments, the base member 30 is configured to provide a support surface for receiving and mounting the tank 20, which preferably includes a plurality of screw or bolt holes SH (three shown in the illustrated embodiment) for receiving respective screws or bolts therethrough. As discussed above, in the preferred embodiments, such screws or bolts can be screwed into respective receiving holes in the bottom of the tank 20 (such as shown in FIG. 2).

As also shown in FIG. 9, in the preferred embodiments, the supporting surface of the base member 30 beneath the tank 20 is preferably configured to accommodate a structure of the tank in which the bottom of the tank 20 has a recessed central region and includes in the rearward direction to facilitate automatic emptying of water from the tank 20 after use. Towards this end, in the illustrated embodiment, the tank supporting surface of the base member preferably has raised support projections (as shown in FIG. 9) with the corresponding screw or bolt holes SH for receiving of the tank. As also shown in FIG. 9, in the preferred embodiments, the tank support surface of the base member also preferably includes a large inlet hole IH via with the inlet to the tank 20 is connected to the water tubing as discussed above. In addition, in the preferred embodiment, this inlet hole IH is at a lowest point of the tank support surface of the base member 30, and this inlet hole is also preferably both within a floor surface and a rear wall surface. In this manner, excess water can freely flow out of the inlet hole IH. In addition, this structure can also facilitate fabrication of the device when joining the tank to the base member.

As also shown in FIG. 9, in some preferred embodiments, the base member 30 also includes a flow channel FC which helps to ensure that water that enters the handle portion HL or recess RC (whether inadvertently or during operation of the sprinkler) can freely flow out of the traveling sprinkler 10 (such as, e.g., via the inlet hole IH).

As also shown in FIG. 9, in the preferred embodiments, the base member 30 includes a cover portion 30A. As indicated above, in the preferred embodiment, the cover member 30A is an aesthetic member with a smooth contour. In addition, the cover member 30A also preferably operates as a fender to cover the rear wheels RW as discussed herein above. Moreover, as shown in the enlarged view of FIG. 12, in the preferred embodiments, the cover member 30A also includes indicia ID denoting the desired positions of the speed control SC knob, such as, e.g., Hi, Lo and Neutral in some embodiments. As also shown in FIGS. 9 and 12, in the illustrated embodiment, the base member includes a through-hole SHB in the supporting portion 30B and a aligned through-hole SHA in the cover portion 30A through which the rotated shaft freely rotates. Towards that end, it should be appreciated that the rotating shaft RS is not fixed to any member, other than being rotatably supported on the stationary shaft SS. Moreover, as shown in FIG. 2, the upper end of the stationary shaft is preferably configured to have an outwardly extending annular portion that overlaps with and, thus, engages with an inwardly extending annular ledge within the rotated shaft RS. In that manner, during application of water pressure, the rotated shaft will still be retained on the stationary shaft SS. As indicated above, there is also preferably at least one o-ring between these shafts to enhance the seal therebetween. During assembly, the stationary shaft can be inserted within the rotated shaft and, thereafter, the stationary shaft can be screwed into the shaft support member SSM as discussed above.

As also shown in FIGS. 9 and 12, in the preferred embodiments, the base member also preferably includes respective through-holes SCA and SCB within the cover member 30A and the bottom member 30B, respectively, in order to receive the speed control shaft SCS rotatably therein as discussed above.

As discussed above, FIG. 13 is an enlarged view of the combined sprinkler arm and rotated shaft assembly shown in FIG. 9 to facilitate reference and viewing of the components. As shown in FIG. 13, in the illustrated embodiment, two sprinkler arms SA are fixedly connected to the rotated shaft RS via a T-shaped connector TBC which splits the flow from a single path upward through the rotated shaft to two lateral paths down the respective sprinkler arms SA. As also shown in FIG. 13, the distal ends of the sprinkler arms also include discharge nozzles DN that facilitate spraying of the water exiting from the sprinkler arms.

Although the preferred embodiment includes two sprinkler arms, in other embodiments, the number of sprinkler arms can be varied as desired, and can include, 3, 4, 5, 6 or more sprinkler arms or simply just one sprinkler arm in some embodiments. However, in the preferred embodiment, two sprinkler arms are employed.

### Broad Scope of the Invention

While illustrative embodiments of the invention have been described herein, the present invention is not limited to the various preferred embodiments described herein, but includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to.” In this disclosure and during the prosecution of this application, means-plus-function or step-plus-function limitations will only be employed where for a specific claim limitation all of the following conditions are present in that limitation: a) “means for” or “step for” is expressly recited; b) a corresponding function is expressly recited; and c) structure, material or acts that support that structure are not recited. In this disclosure and during the prosecution of this application, the terminology “present invention” or “invention” may be used as a reference to one or more aspect within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure, the following abbreviated terminology may be employed: “e.g.” which means “for example.”

What is claimed is:

1. A traveling sprinkler system, comprising:
a) a base member supporting each of a gear mechanism, at least one rotating sprinkler arm, a plurality of wheels including at least one wheel driven via said gear mechanism, and a water tank;
b) said water tank being supported upon a support surface of the base member;
c) a water flow path extending upright through said base member from a location proximate a bottom of the base member upward and through a top wall of the base member to at least one laterally extending sprinkler arm, said water flow path including a rotated shaft that is caused to rotate by water flow through said water flow path, and said rotated shaft having a gear mechanism for imparting driving motion for the at least one when driven via said gear mechanism;
d) said water tank being supported on said support surface of said base member at a forward position of said traveling sprinkler system from said water flow path that extends upright through said base member.

2. The traveling sprinkler system of claim 1, wherein said base member is made from a molded plastic material.

3. The traveling sprinkler system of claim 1, wherein a bottom of said water tank is lower than a bottom of said rotated shaft.

4. The traveling sprinkler system of claim 1, wherein said water tank has a water inlet at a bottom-most point of the water tank.

5. The traveling sprinkler system of claim 4, wherein the bottom of said water tank slopes downwardly to said water inlet.

6. The traveling sprinkler system of claim 1, wherein a junction between a rear wall of said water tank and a front wall at an upper end of the base member includes a handle portion for manually holding the traveling sprinkler system.

7. The traveling sprinkler system of claim 1, wherein said traveling sprinkler system has a handle portion formed at a central top region of the traveling sprinkler.

8. The traveling sprinkler system of claim 1, wherein said traveling sprinkler system includes a handle portion formed within a top of the base member and a corresponding recess within the top of the water tank to facilitate grasping of the handle portion.

9. The traveling sprinkler system of claim 1, wherein said tank includes a float valve contained within a removable cap on a top wall of said tank.

10. The traveling sprinkler system of claim 9, wherein said float valve includes a buoyant member that seals at least one air passage opening within the cap when the water level within the tank reaches the buoyant member, and that unseals the at least one air passage opening within the cap when the water level within the tank lowers below the buoyant member.

11. The traveling sprinkler system of claim 10, wherein said buoyant member is a floatable ball shaped member.

12. The traveling sprinkler system of claim 10, wherein said buoyant member is a generally T-shaped member having a lower sealing o-ring or other member.

13. The traveling sprinkler system of claim 1, wherein the sprinkler system includes two rear wheels that are driven via the gear mechanism and a front wheel that is configured to roll along a hose.

14. A traveling sprinkler system, comprising:
a) a base member supporting each of a gear mechanism, at least one rotating sprinkler arm, a plurality of wheels including at least one wheel driven by said gear mechanism, and a water tank;
b) said water tank being supported upon a support surface of the base member;
c) a water flow path extending upright through said base member from a location proximate a bottom of the base member upward and through a top wall of the base member to at least one laterally extending sprinkler arm, said water flow path including a rotated shaft that is caused to rotate by water flow through said water flow path, and said rotated shaft having a gear mechanism for imparting driving motion for the at least one when driven via said gear mechanism; and
d) wherein said tank includes a float valve contained within a removable cap on a top wall of said tank.

15. The traveling sprinkler system of claim 14, wherein said float valve includes a buoyant member that seals at least one air passage opening within the cap when the water level within the tank reaches the buoyant member, and that unseals the at least one air passage opening within the cap when the water level within the tank lowers below the buoyant member.

16. The traveling sprinkler system of claim 15, wherein said buoyant member is a floatable ball shaped member.

17. The traveling sprinkler system of claim 15, wherein said buoyant member is a generally T-shaped member having a lower sealing o-ring or other member.

18. A method for using the traveling sprinkler according to claim 1, comprising:
attaching a hose to said rotating sprinkler and having water initially enter said tank and then cause said sprinkler arms to rotate and to cause said traveling sprinkler to travel.

19. A method for using the traveling sprinkler according to claim 14, comprising:
attaching a hose to said rotating sprinkler and having water initially enter said tank and then cause said sprinkler arms to rotate and to cause said traveling sprinkler to travel.
